(19) United States
(12) Patent Application Publication
(10) Pub. No.: US 2025/0214813 A1
(43) Pub. Date: Jul. 3, 2025

(54) PULLEY DEVICE

(71) Applicant: GD IND Corp., Incheon (KR)

(72) Inventor: Tae Jin An, Incheon (KR)

(73) Assignee: GD IND Corp., Incheon (KR)

(21) Appl. No.: 19/001,812

(22) Filed: Dec. 26, 2024

(30) Foreign Application Priority Data
Dec. 29, 2023 (KR) 10-2023-0197005
Dec. 3, 2024 (KR) 10-2024-0177710

(51) Int. Cl. B66D 3/04

(52) U.S. Cl. CPC B66D 3/04; B66D 2700/026

(57) ABSTRACT

A pulley device according to the present disclosure includes a loop string including a ring-shaped loop portion formed in an upper portion and first and second string extension portions extending downward, a loop fixing stopper through which the first and second string extension portions pass and to which a loop portion is connected to form a knot, and a pulley to which the first and second string extension portions are connected and which includes a pulley wheel.

### CROSS-REFERENCE TO RELATED APPLICATIONS

This application claims the priority of Korean Patent Applications No. 10-2023-0197005 filed on Dec. 29, 2023, and No. 10-2024-0177710 filed on Dec. 3, 2024, in the Korean Intellectual Property Office, the disclosure of which is incorporated herein by reference.

### BACKGROUND

### Field

The present disclosure relates to a pulley device, and more specifically, to a pulley device that may be used for connecting a pulley to a support using a loop string.

### Description of the Related Art

A pulley is a device that moves an object by hanging a rope or the like on a pulley wheel. The pulley is mainly used to change the direction of an applied force.

A known pulley includes a pulley wheel and a pulley housing that rotatably supports the pulley wheel. The pulley is used by fixing the pulley housing to a support and hanging a cable or the like on the pulley wheel.

The known pulley is provided with a metal hook, ring, biner, or the like in the pulley housing to fix the pulley to the support, or a bracket for fixing the pulley to a support through a bolt fastening. This known pulley structure has a disadvantage in that the work of fixing the pulley to the support is cumbersome in order to use the pulley.

For example, when the pulley is fixed to the support to lift an object using the pulley, it is difficult to use the pulley when there is no support capable of fastening a hook or the like at position near to the pulley.

In addition, a pulley has been used as exercise equipment for rehabilitation treatment in recent years. For example, Korean Utility Model Publication No. 20-1999-0001642 discloses exercise equipment using a pulley. However, the disclosed pulley exercise equipment has a problem in that the pulley should be fixed to a fixed surface of a ceiling using a bolt.

### SUMMARY

An object of the present disclosure is to provide a pulley device that is easy to connect a pulley to a support using a loop string and easy to adjust the position of the pulley.

In addition, an object of the present disclosure is to provide a pulley device capable of performing arm stretching exercise.

A pulley device according to one embodiment of the present disclosure includes a loop string, a pulley, and a loop fixing stopper. The loop string includes a loop portion formed in a ring shape on one side and first and second string extension portions extending to the other side in a form bifurcated from the loop portion. When the loop string is hung on a support located on the upper side, the loop portion extends downward together with the first and second string extension portions. The loop fixing stopper has first and second through-hole rows through which the first and second string extension portions pass, and may form a knot for fixing the loop string when the loop portion of which a direction is changed over the support to extend downward is hung on a rear surface. The pulley includes a pulley housing to which end portions of the first and second string extension portions are connected, and a pulley wheel rotatably mounted by a connecting shaft between two connecting plates of the pulley housing. A groove through which a movable string may pass while rotating is formed on the circumference of the pulley wheel.

According to an embodiment of the present disclosure, the first and second through-hole rows of the loop fixing stopper include an upper through-hole that allows the first and second string extension portions to extend from a rear surface to a front surface, and a lower through-hole that allows the first and second string extension portions to extend from the front surface to the rear surface.

According to an embodiment of the present disclosure, the loop fixing stopper includes a main plate in which the first and second through-hole rows are formed, and two side walls protruding from both sides of the main plate in a rear surface direction. Two side walls allow the loop portion hung between the rear surface of the main plate and the first and second string extension portions to extend between two side walls. As a result, the loop portion interferes with the first and second string extension portions to firmly fix the loop string.

According to an embodiment of the present disclosure, the pulley housing includes a string coupling portion formed as a through-hole through which an end portion of each of the first and second string extension portions extends on an upper surface. The end portion of each of the first and second string extension portions inserted through the string coupling portion is fixed as to prevent separation in a coupling space formed in the upper portion inside the pulley housing.

According to an embodiment of the present disclosure, the pulley device further includes a moving string having two moving string extension portions hung on the groove of the pulley wheel and extending downward, and a handle coupled to a lower portion of each of the moving string extension portions, in which an arm stretching movement is performed by the moving string and handle.

According to an embodiment of the present disclosure, a hollow through which the moving string extension portion is inserted, and passes is formed in the handle, and a string stopper is provided in the moving string extension portion to connect the handle and enable height adjustment of the handle. An insertion hole path and a fixing hole path are formed inside the body of the string stopper.

According to the pulley device according to the present disclosure, the pulley may be easily connected to the support using the loop string and the loop string stopper. In addition, the height at which the pulley is suspended in the air may be easily adjusted by moving the loop fixing stopper in a state where the pulley is suspended in the air using the loop string on the support located on the upper side.

The pulley device according to the present disclosure may be used not only for lifting objects or pulling objects, but also as an arm stretching exercise device for rehabilitation treatment, or the like.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view of a pulley device according to one embodiment of the present disclosure.

FIG. 2 is a perspective view illustrating a state where the pulley device according to one embodiment of the present disclosure is connected to a support.

FIG. 3 is a cross-sectional view illustrating coupling between a loop string and a pulley in the pulley device according to one embodiment of the present disclosure.

FIG. 4 is a front (F) perspective view of a loop fixing stopper according to one embodiment of the present disclosure.

FIG. 5 is a rear (B) perspective view of the loop fixing stopper according to one embodiment of the present disclosure.

FIG. 6 is a view for explaining coupling of strings of the loop fixing stopper according to one embodiment of the present disclosure.

FIGS. 7A and 7B are views illustrating adjustment of the length of the loop string and adjustment of the height of a pulley according to movement of the loop fixing stopper in the pulley device according to one embodiment of the present disclosure.

FIG. 8 is a perspective view illustrating a state where a moving string and a handle are connected to the pulley device according to one embodiment of the present disclosure.

FIG. 9 is a cross-sectional view of a string stopper of the pulley device according to one embodiment of the present disclosure.

FIGS. 10A and 10B are views for explaining a method for adjusting the height of the handle using the string stopper of the pulley device according to one embodiment of the disclosure.

### DETAILED DESCRIPTION OF THE EMBODIMENT

Hereinafter, specific details for implementing the present disclosure will be described with reference to the attached drawings. In addition, in describing the present disclosure, when it is judged that related known functions are obvious to those skilled in the art and may unnecessarily obscure the gist of the present disclosure, a detailed description thereof will be omitted.

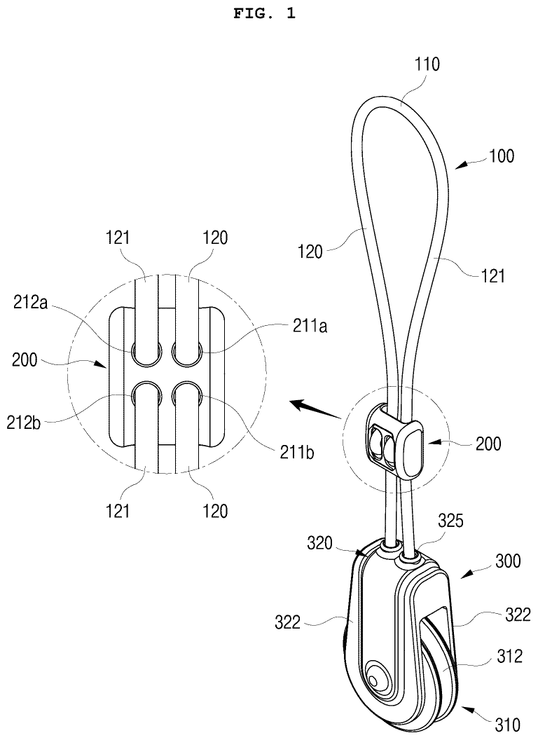

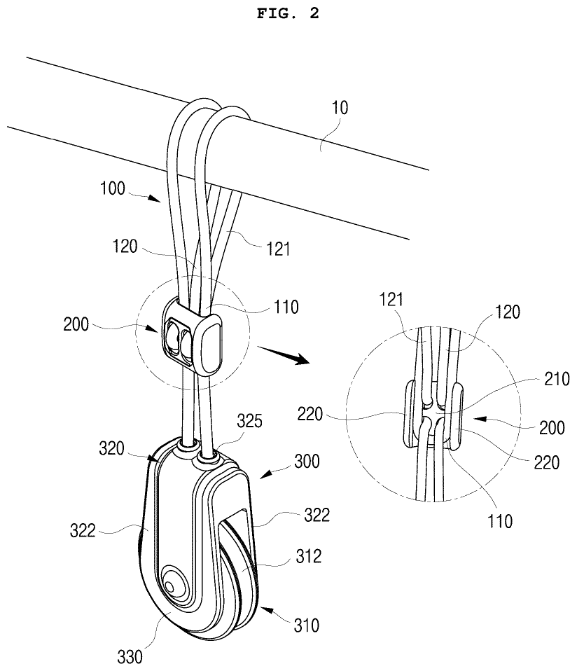

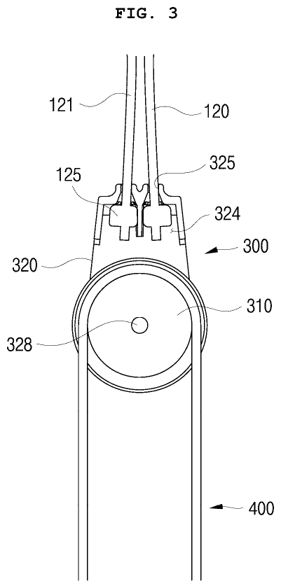

FIG. 1 illustrates a pulley device according to one embodiment of the present disclosure, FIG. 2 illustrates a state where the pulley device is connected to a support as an example of the use of the pulley device according to one embodiment of the present disclosure, and FIG. 3 illustrates a state where a loop string is coupled to in a pulley housing in the pulley device according to one embodiment of the present disclosure.

Referring to the drawings, the pulley device according to the present disclosure includes a loop string 100, a loop fixing stopper 200, and a pulley 300.

According to one embodiment of the present disclosure, the pulley 300 is connected to a rod-shaped support 10 through a loop string 100 and is suspended in the air. The support 10 includes various structures by which the loop string 100 may be supported, such as a straight rod, a bracket fixed to a wall, or the like.

The loop string 100 includes a loop portion 110 formed in a ring shape on one side and first and second string extension portions 120 and 121 that extend to the other side in a form bifurcated from the loop portion 110. The loop string 100 may be hung in a manner of being passed above the support positioned on the upper side, and the loop portion 110 is pulled downwards and connected to a loop fixing stopper 200 to form a knot that fixes the loop string 100 to the support 10.

End portions 125 of the first and second string extension portions 120 and 121 are fixed to the pulley 300. In the present specification, a loop string 100 means a string having the ring-shaped loop portion 110 in the middle thereof, and a portion of a single string folded to form a ring becomes the loop portion 110, and a portion that extends to be bifurcated from the loop portion 110 becomes the first and second string extension portions 120 and 121. The string in the present specification is used as a concept that includes a string, a rope, a cable, and the like, and similar things.

The pulley 300 includes a pulley wheel 310 and a pulley housing 320.

The pulley housing 320 includes two facing connecting plates 322, and the pulley wheel 310 is positioned between the two connecting plates 322 and is rotatably supported by a connecting shaft 328.

A string coupling portion 325 to which both end portions 125 of the loop string 100 are fixed is formed on the upper surface of the pulley housing 320. The string coupling portion 325 may be formed as a through-hole through which the first and second string extension portions 120 and 121 pass through, respectively.

Both end portions 125 of the loop string 100, that is, the end portions 125 of the first and second string extension portions 120 and 121, are inserted into the interior of the pulley housing 320 through the string coupling portion 325 and are fixed. The end portion 125 of the loop string 100 may be tied to form a node inside the pulley housing 320 or fixed by coupling a fixture. As a result, the loop string 100 may be connected without being separated from the pulley housing 320.

In the inner upper portion of the pulley housing 320, a coupling space 324 is formed between the pulley wheel 310 and the upper end of the pulley housing 320 in which the string coupling portion 325 is formed, so as not to impede the rotation of the pulley wheel 310 by the node or fixture formed at the end portion 125 of the loop string 100.

A groove 312 through which a moving string 400 passes while rotating in a circumferential direction is formed in the pulley wheel 310. The direction of the moving string 400 is changed while the moving string is hung on the groove 312, and when the moving string 400 is pulled to one side or the other, the pulley wheel 310 rotates along with the movement of the moving string 400. The string connected to the pulley wheel 310 is referred to as a moving string because the string operates together with the pulley wheel 310.

The loop fixing stopper 200 is movably connected to the first and second string extension portions 120 and 121 of the loop string 100.

The loop string 100 is passed over the support 10 and the direction thereof is changed, thereby extending downwards together with the loop portion 110 and the first and second string extension portions 120 and 121. The loop portion 110 pulled to the position of the loop fixing stopper 200 is hung on the loop fixing stopper 200 and comes into contact with the first and second string extension portions 120 and 121, thereby forming a knot that fixes the loop string 100. When the loop fixing stopper 200 is moved along the first and second string extension portions 120 and 121, the position, i.e., the height, of the pulley 300 fixed to the first and second string extension portions 120 and 121 is adjusted.

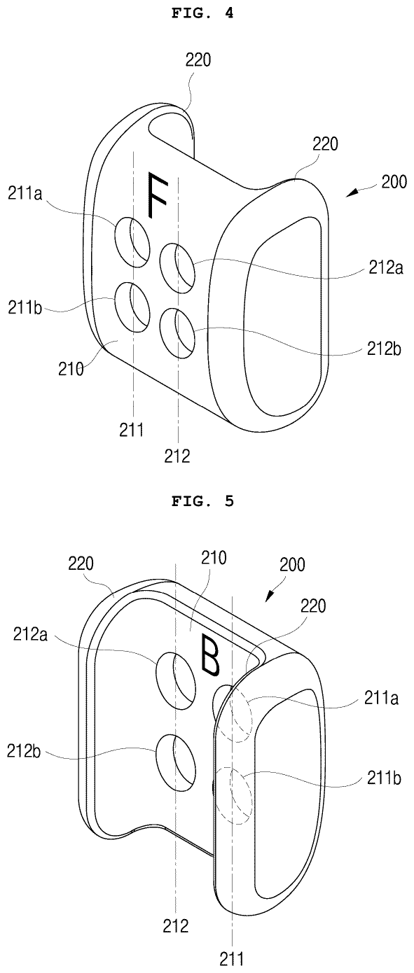

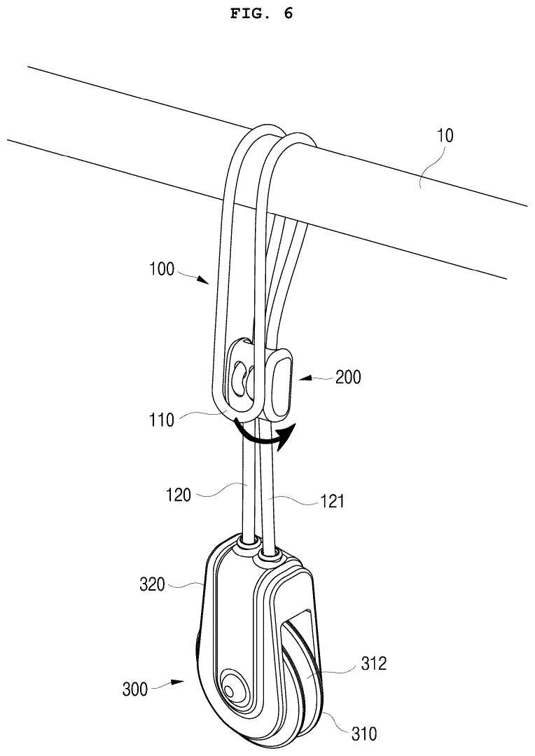

FIGS. 4 and 5 are a front (F) and a rear (B) perspective view of the loop fixing stopper according to an embodiment of the present disclosure.

Referring to FIGS. 1 to 5, the loop fixing stopper 200 includes a main plate 210 and two side walls 220 protruding from the side end of the main plate 210 toward the direction of a rear surface B.

The main plate 210 is formed with first and second through-hole rows 211 and 212 on the left and right. Each of the first and second through-hole rows 211 and 212 include at least one through-hole into which the first and second string extension portions 120 and 121 are inserted and which extend from the front surface F to the rear surface B.

According to an embodiment of the present disclosure, the first and second through-hole rows 211 and 212 include upper through-holes 211a and 212a and lower through-holes 211b and 212b.

Each of the first and second through-hole rows 211 and 212 forms a path through which each of the first and second string extension portions 120 and 121 extends. As illustrated in the enlarged view of FIG. 1, the upper through-holes 211a and 212a form a path through which the first and second string extension portions 120 and 121 pass through from the rear surface B of the main plate 210 toward the front surface F. The lower through-holes 211b and 212b form a path through which the first and second string extension portions 120 and 121, which are drawn out to the front surface F through the upper through-holes 211a and 212a, pass through from the front surface F toward the rear surface B. The first and second string extension portions 120 and 121 pass through the lower through-holes 211b and 212b and extend toward the pulley 300, and are fixed to the pulley 300 through the string coupling portion 325.

When two side walls 220 form a knot to fix the loop string 100 via the loop fixing stopper 200, the loop portion 110 is fixed between the two side walls 220 to prevent separation.

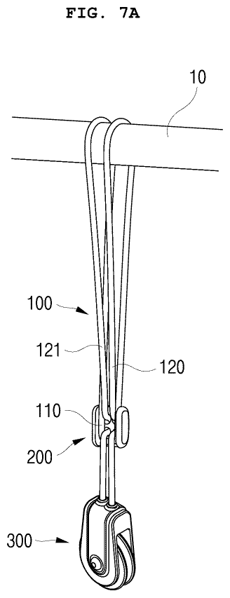

FIG. 6 is a view for explaining the process in which the loop portion of the loop string is coupled and fixed to the loop fixing stopper.

Referring to FIG. 6, first, the loop portion 110 of the loop string 100 is passed over the support 10 so as to hang over the support 10, and then the loop portion 110 is pulled to the position of the loop fixing stopper 200. Thereafter, the loop portion 110 is moved to the rear surface side of the loop fixing stopper 200, and then the pulley 300 is pulled down.

As a result, as illustrated in the enlarged view of FIG. 2, the loop portion 110 passes through the first and second through-hole rows 211 and 212 at the rear surface B of the loop fixing stopper 200 and then, is hung on the first and second string extension portions 120 and 121 extending downward. That is, the loop portion 110 is interposed between the rear surface B of the loop fixing stopper 200 and the first and second string extension portions 120 and 121, and the first and second string extension portions 120 and 121 that pass through the first and second through-hole rows 211 and 212 pass through the loop portion 110 and extend downward.

When the pulley 300 to which the first and second string extension portions 120 and 121 are coupled is pulled, a downward tension is applied to the first and second string extension portions 120 and 121 and an upward tension is applied to the loop portion 110, thereby causing a tightening that fixes the loop portion 110. In the present specification, fixing of the loop string 100 as described above via the loop fixing stopper 200 is referred to as forming a knot. According to the present disclosure, the loop portion 110 is extended between two side walls 220, thereby preventing the loop portion 110 from spreading outward, and the loop portion 110 and the first and second string extension portions 120 and 121 interfere with each other, thereby causing jamming, thereby strongly fixing the knot.

Since the loop string 100 is fixed by a knot formed by the loop fixing stopper 200, the pulley 300 may be maintained in a state of being hung on the support 10 by the loop string 100 at an adjusted position.

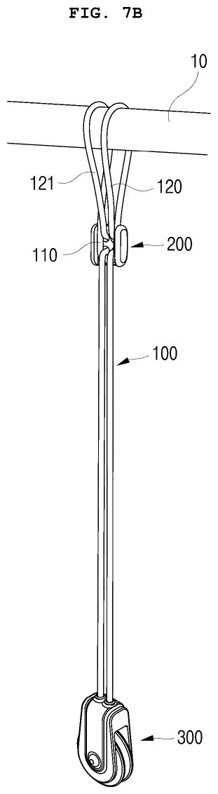

FIGS. 7A and 7B are views for explaining the adjustment of the length of the loop string and the height of the pulley according to the movement of the loop fixing stopper. FIG. 7A illustrates a state in which the loop fixing stopper 200 has moved downward along the first and second string extension portions 120 and 121, and FIG. 7B illustrates a state in which the loop fixing stopper 200 has moved upward from the position illustrated in FIG. 7A along the first and second string extension portions 120 and 121.

As illustrated in FIG. 7A, when the loop fixing stopper 200 moves downward along the first and second string extension portions 120 and 121, the length of the loop string 100 overlapping above the loop fixing stopper 200 increases. Accordingly, the length of the loop string 100 extending downwardly shortens, and the pulley 300 located below the loop fixing stopper 200 rises. Conversely, as illustrated in FIG. 7B, when the loop fixing stopper 200 moves upward along the first and second string extension portions 120 and 121, the length of the loop string 100 overlapping above the loop fixing stopper 200 decreases. Accordingly, the length of the loop string 100 extending downward increases, and the pulley 300 located below the loop fixing stopper 200 is lowered.

According to the present disclosure, the knot for fixing the loop string 100 is formed by hanging the loop portion 110 on the loop fixing stopper 200 after hanging the loop string 100 on the support, so that the work of hanging the pulley 300 in the air may be easily performed. In addition, the distance between the support 10 and the pulley 300 may be easily adjusted by moving the loop fixing stopper 200 along the first and second string extension portions 120 and 121. Therefore, the height at which the pulley 300 is hung in the air may be easily adjusted.

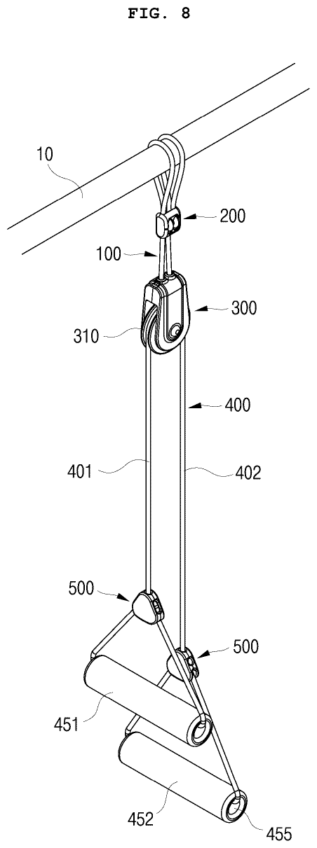

FIG. 8 illustrates an example in which the pulley device according to one embodiment of the present disclosure is implemented as an arm stretching exercise mechanism. The pulley device according to one embodiment of the present disclosure further includes a moving string and a handle to enable arm stretching exercise.

Referring to FIG. 8, a moving string 400 is extended to both sides while being hung by the groove 312 of the pulley wheel 310, and the extended portions forms moving string extension portions 401 and 402. Handles 451 and 452 are fixed to the moving string extension portions 401 and 402.

When one handle 451 is pulled, the moving string 400 moves along with the rotation of the pulley wheel 310 and the other handle 452 rises. Accordingly, the arm holding the other handle 452 is stretched. In the opposite case, the arm holding one handle 451 is stretched. In this way, the stretching exercise of both arms may be performed by alternately pulling the one and the other handles 451 and 452.

Hollows 455 are formed in the handles 451 and 452 to allow the moving string extension portions 401 and 402 to pass through.

According to an embodiment of the present disclosure, a string stopper 500 is included, which connects the handles 451 and 452 to the moving string extension portions 401 and 402. The string stopper 500 is positionally adjustable along the moving string extension portions 401 and 402, thereby adjusting the height of the handle 451 and 452.

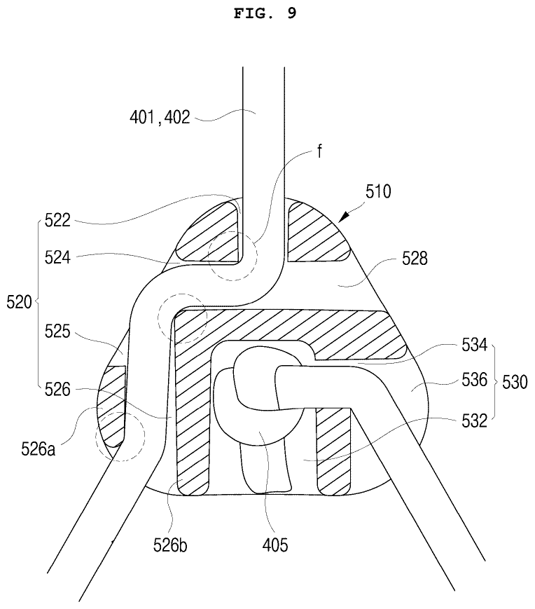

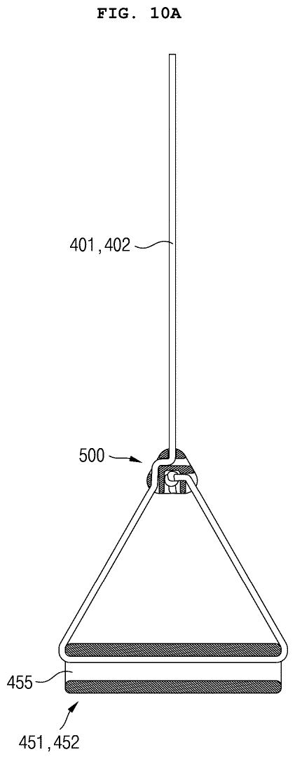

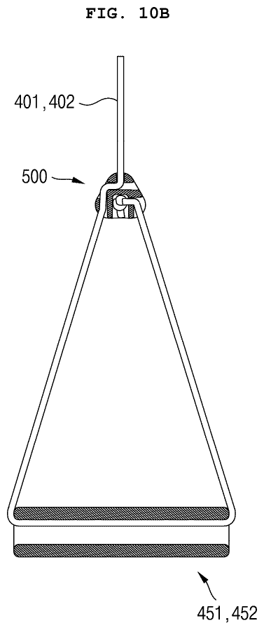

FIG. 9 is a cross-sectional view of the string stopper of the pulley device according to one embodiment of the present disclosure, and FIGS. 10A and 10B are views for explaining that the height of the handle is adjusted using the string stopper illustrated in FIG. 9.

Referring to FIG. 9, a path through which the moving string extension portions 401 and 402 passes is formed inside a body 510 of the string stopper 500. The path includes an insertion hole path 520 through which the moving string extension portions 401 and 402 extending downward from the pulley 300 passes while being bent multiple times inside the body 510 and is discharged outside the body 510, and a fixing hole path 530 through which the end portions 405 of the moving string extension portions 401 and 402 passing through the hollows 455 of the handles 451 and 452 are inserted and fixed.

The body 510 may have a triangular shape with a rounded vertex. Additionally, the body 510 may be formed of a plastic material.

The insertion hole path 520 includes a first insertion hole 522 formed in the upper portion of the body 510 and extending downward, a first side insertion hole 524 that is bent relative to the first insertion hole 522 and extends toward one side of the body 510 from the inside, and a second insertion hole 526 that is bent relative to the first side insertion hole 524 and extends downward. The first side insertion hole 524 extends orthogonally to and intersects the first insertion hole 522, and the second insertion hole 526 extends orthogonally to and intersects the first side insertion hole 524. The second insertion hole 526 is formed so that an outer wall 526a is shorter than an inner wall 526b, so that the moving string extension portions 401 and 402 passing through the second insertion hole 526 extend while spreading outwardly toward the handles 451 and 452. However, this is not limited thereto.

The connection portion 525 of the first side insertion hole 524 and the second insertion hole 526 is formed to be open on one side surface of the body 510. In addition, the body 510 includes a second side insertion hole 528 that is connected to the first side insertion hole 524 and extends in the other direction of the body 510.

The moving string extension portions 401 and 402 extended from the pulley 300 is inserted through the first insertion hole 522, bent, and inserted into the first side insertion hole 524. Since the first side insertion hole 524 extends orthogonally to and intersects the first insertion hole 522, it is difficult for the end portion of the moving string 400 inserted into the first insertion hole 522 to enter the first side insertion hole 524. In this case, a tool may be inserted into the second side insertion hole 528 to cause the moving string extension portions 401 and 402 to enter the first side insertion hole 524. The moving string extension portions 401 and 402 inserted through the first side insertion hole 524 may be pulled outward from the body 510 through the opened connection portion 525. After this, the moving string extension portions 401 and 402 are inserted into the second insertion hole 526 and pulled down. Through this, the moving string extension portions 401 and 402 are discharged to the outside of the body 510 and extended toward the handles 451 and 452.

In the insertion hole path 520, the moving string extension portions 401 and 402 are bent while passing through the first insertion hole 522, the first side insertion hole 524, and the second insertion hole 526 and are discharged outside the body 510. A frictional force is generated at the boundary of the first insertion hole 522, the first side insertion hole 524, and the second insertion hole 526 where the moving string extension portions 401 and 402 bend, and this friction point f serves to strengthen the fixing effect of the moving string 400 when tension is applied to the moving string 400. Since the moving string extension portions 401 and 402 are prevented from slipping even when a large force is applied to the handles 451 and 452 by bending inside the body 510 and forming the friction point f.

The moving string extension portions 401 and 402 discharged from the string stopper 500 pass through the hollows 455 of the handles 451 and 452 and the end portion 405 is inserted into and fixed in the fixed hole path 530 of the string stopper 500.

The fixed hole path 530 is formed at the lower portion of the body 510 and includes an end portion fixing hole 532 to which the end portions 405 of the moving string extension portions 401 and 402 are fixed, and an end portion insertion hole 534 that is connected to intersect the end portion fixing hole 532 and extends in the other direction of the body 510. The end portion fixing hole 532 and the first insertion hole 522 are arranged on the central axis of the body 510. The other side surface of the body 510 where the end portion insertion hole 534 is formed forms an opening portion 536 that is open in the lower and side directions. The opening portion 536 is located opposite the second insertion hole 526.

The moving string extension portions 401 and 402 are inserted into the end portion fixing hole 532 through the opening portion 536 and the end portion insertion hole 534 on the other side of the body 510. The end portions 405 of the moving string extension portions 401 and 402 are tied to form a node or disposed in the end portion fixing hole 532 in a state of being coupled to the fixture to prevent separation. In this way, the work of connecting the handles 451 and 452 to the moving string extension portions 401 and 402 is completed.

The opening portion 536 formed on the other side of the body 510 allows the moving string extension portions 401 and 402 introduced into the end portion insertion holes 534 to extend symmetrically from the string stopper 500 on both sides. Accordingly, the moving string extension portions 401 and 402 below the body 510 may form a symmetrical arrangement with respect to the central axis of the string stopper 500.

Since the moving string 400 is extended while being bent multiple times inside the body 510 of the string stopper 500, when tension is formed in the moving string 400, the frictional force increases, thereby increasing the effect of fixing the moving string.

Referring to FIGS. 10A and 10B, the positions of the handles 451 and 452 may be adjusted by moving the moving string 400 along the insertion hole path 520. As illustrated in FIG. 10A, when the string stopper 500 is moved downward along the moving string extension portions 401 and 402, the length of the overlapping of the moving string extension portions 401 and 402 between the string stopper 500 and the handles 451 and 452 is shortened, so that the positions of the handles 451 and 452 may be adjusted downward. Conversely, as illustrated in FIG. 10B, when the string stopper 500 is moved upward along the movable string extension portions 401 and 402, the overlapping length of the movable string extension portions 401 and 402 between the string stopper 500 and the handles 451 and 452 increases, so that the positions of the handles 451 and 452 may be adjusted upward. In this manner, the heights of the handles 451 and 452 may be adjusted to suit the size of a user's body.

The string stopper 500 according to the present disclosure is attractive in appearance because the moving string 400 is bent while passing through the inside of the body 510, and the bent portion is not exposed to the outside. In addition, since sufficient rigidity may be secured even when the body 510 is formed of a plastic material, the manufacturing cost may be reduced compared to a stopper made of a metal material.

The scope of protection in this field is not limited to the description and expression of the embodiments explicitly described above. In addition, it is added once again that the scope of protection of the present disclosure may not be limited due to obvious changes or substitutions in the technical field to which the present disclosure belongs.

What is claimed is:

1. A pulley device comprising:
a loop string including a loop portion formed in a ring shape on one side and first and second string extension portions extending to the other side in a form bifurcated from the loop portion, the loop portion extending downward together with the first and second string extension portions when the loop string is hung on a support located on an upper side;
a loop fixing stopper having first and second through-hole rows through which the first and second string extension portions pass, and forming a knot for fixing the loop string when the loop portion is hung on a rear surface; and
a pulley including a pulley housing to which end portions of the first and second string extension portions extended through the loop fixing stopper are connected, and a pulley wheel rotatably mounted between two connecting plates of the pulley housing by a connecting shaft and having a circumference around which a groove around which a moving string passes while rotating is formed.

2. The pulley device of claim 1, wherein the loop fixing stopper is positionally adjustable while moving along the first and second string extension portions, thereby allowing a position at which the pulley is suspended in the air by the loop string to be adjusted.

3. The pulley device of claim 2, wherein the first and second through-hole rows of the loop fixing stopper include an upper through-hole that allows the first and second string extension portions to extend from a rear surface to a front surface, and a lower through-hole that allows the first and second string extension portions to extend from the front surface to the rear surface.

4. The pulley device of claim 2, wherein the loop fixing stopper includes a main plate in which the first and second through-hole rows are formed and two side walls protruding from both sides of the main plate in a rear surface direction, and
two side walls support the loop portion hung between the first and second string extension portions and the rear surface of the main plate so that the loop portion extends between two side walls.

5. The pulley device of claim 1, wherein the pulley housing includes a string coupling portion formed as a through-hole on the upper surface, into which an end portion of each of the first and second string extension portions is inserted, and
the end portions of the first and second string extension portions are fixed so as to prevent separation in a coupling space formed in an inner upper portion of the pulley housing.

6. The pulley device of claim 1, further comprising:
a moving string having two moving string extension portions hung on the groove of the pulley wheel and extending downward; and
a handle coupled to a lower portion of each of the moving string extension portions,
wherein an arm stretching movement is performed by the moving string and handle.

7. The pulley device of claim 6, wherein the handle includes a hollow through which the moving string extension portion is inserted and passes,
a string stopper is provided in the moving string extension portion to connect the handle and enable height adjustment of the handle,
an insertion hole path and a fixing hole path are formed inside a body of the string stopper,
the insertion hole path is configured such that the moving string extension portion bends inside the body, exits, and extends toward the handle, and the moving string extension portion is secured by frictional force generated while being bent inside the body, and
the fixing hole path is configured to allow the end portion of the moving string extension portion, which passes through the hollow of the handle and extends, to be inserted and fixed.

8. The pulley device of claim 7, wherein the insertion hole path includes a first insertion hole formed on an upper portion of the body and extending downward, a first side insertion hole extending to one side of the body while intersecting the first insertion hole, and a second insertion hole extending downward while intersecting the first side insertion hole.

9. The pulley device of claim 8, wherein a connection portion of the first side insertion hole and the second insertion hole is formed to be open on one side surface of the body, and
a second side insertion hole connected to the first side insertion hole and extending to the other side of the body is formed.

10. The pulley device of claim 7, wherein the fixing hole path includes an end portion fixing hole to which an end portion of the moving string extension is fixed, and an end portion insertion hole that extends in the other direction of the body while intersecting the end portion fixing hole and through which an end portion of the moving string extension portion is inserted into the end portion fixing hole.

11. The pulley device of claim 10, wherein the first insertion hole path and the end portion fixing hole are arranged on a central axis of the body, and
the moving string extension portion forms a symmetrical arrangement with respect to a central axis of the body on a lower side of the body.

12. The pulley device of claim 11, wherein an opening portion through which the moving string extension portion passes is formed opposite to the second insertion hole in the body.
